(19) United States
(12) Patent Application Publication
(10) Pub. No.: US 2025/0196277 A1
(43) Pub. Date: Jun. 19, 2025

(54) TIGHTENING DEVICE FOR TIGHTENING A SERIES OF NUTS PRE-SCREWED ON BOLTS

(71) Applicant: ADMEDE AB, Malmö (SE)

(72) Inventors: Lars JAGD, Malmö (SE); Kenneth JOHST, FREDERIKSBERG C (DK); Gerald MARINITSCH, Kalsdorf (AT)

(21) Appl. No.: 18/849,596

(22) PCT Filed: Mar. 10, 2023
(86) PCT No.: PCT/EP2023/056106

§ 371 Date: Sep. 23, 2024

(30) Foreign Application Priority Data
Mar. 23, 2022 (EP) 22163789.5

(51) Int. Cl. B23P 19/06

(52) U.S. Cl. CPC B23P 19/06

(57) ABSTRACT

Tightening device for tightening a series of nuts pre-screwed on bolts, which bolts are arranged in a linear or in a curved flange connection, wherein each nut comprises a top surface located at one end of the nut, wherein the top surfaces are arranged in a nut plane of the flange connection, and wherein the tightening device comprises a propulsion unit for moving the tightening device along the flange connection, wherein the propulsion unit comprises a continuous drive, wherein in an operating state of the tightening device, the continuous drive is disposed essentially on the nut plane on one or more top surfaces of one or more of the nuts.

### BACKGROUND OF THE INVENTION

The present invention is related to a tightening device for tightening a series of nuts pre-screwed on bolts according to the preamble of claim 1.

In the field of modern energy production, wind turbines play an essential part to provide renewable, sustainable, and clean energy for the energy market. Wind turbines comprise a tower, on which a rotor is mounted, which is connected to an electric generator. The tower can reach a height of 100 meters, 150 meters, or even more depending on the specific requirements resulting from, among others, the location of the wind turbine. The tower consists of several tube segments with a length of for instance 20 meters or 30 meters. These segments are connected by circular flange connections on each side of the tube segments. During erection of the wind turbine on site, the tube segments are fitted together and connected with the joint circular flange connections with bolts and nuts. Large quantities of bolts, typically in the hundreds, of large size are necessary to establish the required stiffness and strength of the connections. In order to achieve the appropriate defined stiffness and strength in the joints, all the bolts have to be bolted down with a predefined preload or torque, and according to a specific bolt tightening pattern.

Previously, this operation was performed manually, using torque wrenches or similar tools. Therefore, the construction of wind turbine towers was very labor intensive. In order to speed up the construction, robots were developed which performed the bolt tightening sequence automatically. Document EP 2 607 685 A1 discloses a robot to bolt down a series of nut bolts in a joint circular flange connection of a wind turbine. This robot comprises at least two wheels and a drive to transport the robot along the series of nut bolts and a tool to bolt down a nut bolt with a predefined torque. This drive used in this robot is a belt drive, which interacts with a side wall of the tower in order to propel itself forward. In order to achieve enough friction with the side wall, several electromagnets are provided, to press the belt drive against the side wall. Using the side wall as a means to propel the robot forward is beneficial, because no obstacles like metal filings, other tools, or further obstructions can be encountered on the side wall. This construction therefore leads to a reliable propulsion of the robot. A disadvantage of this solution is, that these electromagnets lead to significant power requirements for the operation of the robot and increase the complexity and cost of the robot.

The technical problem of the present invention is therefore to provide a means for automatically tightening the bolts of a flange connection, which is cheaper and easier to produce than previous solutions, while still providing reliable propulsion along the flange connection.

This problem is solved by the provision of a tightening device according to the subject matter of claim 1. The tightening device according to the invention is configured for tightening a series of nuts pre-screwed on bolts. These bolts are arranged in a linear or in a curved flange connection, wherein each nut comprises a top surface located at one end of the nut. The top surfaces are arranged in a nut plane of the flange connection, and the tightening device comprises a propulsion unit for moving the tightening device along the flange connection. The propulsion unit of the device comprises a continuous drive. According to the invention, in an operating state of the tightening device, the continuous drive is disposed essentially on the nut plane on one or more top surfaces of one or more of the nuts.

The top surfaces of the nuts are always arranged in the nut plane, since even if the nuts are not yet tightened, the weight of the bolts ensures, that the nuts always abut against the flange connection of the respective tube segment of the tower. Therefore, the nut plane always provides a level plane on which the continuous drive can operate. Also, the top surfaces of the nuts are always free from obstacles, which may hinder the locomotion of the tightening device. Furthermore, by using a continuous drive, the advantage is achieved, that the continuous drive interacts with the nuts in a way, that the continuous drive can also grip the edges of the nuts and can use these edges to provide grip. Additionally, the continuous drive is very robust and long lasting. The construction of the tightening device according to the invention therefore provides the advantage of a reliable and robust means of propulsion, which does not need any additional mechanism for attaching the continuous drive to the drive surface, and is therefore less complicated and cheaper to produce than known solutions in the prior art.

According to a preferred embodiment of the tightening device according to the invention, the propulsion unit comprises a guide element, which in the operating state of the tightening device is preferably facing a side surface of one or more of the nuts or bolts of the flange connection. The guide element decreases the risk, that the continuous drive leaves the top surfaces of the nuts during operation of the tightening device. This is particularly beneficial when operating the tightening device at high speeds.

The continuous drive preferably comprises a chain of interlinked chain segments, wherein one or more of the chain segments preferably comprises a friction element oriented towards the nut plane in the operating state, wherein the friction element is preferably made of a rubber or plastic material. The friction element increases the friction of the continuous drive against the top surfaces of the nuts. The friction element is also preferably replaceable. By replacing the friction element, the lifecycle of the continuous drive can be extended. The friction element may also be glued to the chain segment. According to the preferred embodiment of the tightening device according to the invention, each of the chain segments comprises at least one friction element. The chain is, in an operating state of the tightening device, disposed essentially on the nut plane on one or more top surfaces of one or more of the nuts. According to an alternative embodiment, the continuous drive may comprise a drive belt, which may have a circular or a flat cross section wherein in an operating state of the tightening device, the drive belt is disposed essentially on the nut plane on one or more top surfaces of one or more of the nuts.

The propulsion unit may preferably comprise a swivel joint, which pivotably supports the continuous drive. The swivel joint enables the continuous drive to adapt to different curvatures and radii of the flange connection.

According to the preferred embodiment, the tightening device also comprises a positioning unit, which is adapted to control the continuous drive according to positioning information. This positioning unit preferably comprises a camera, which in the operating state of the tightening device is configured to capture image data of the flange connection, wherein the positioning unit is configured to extract the positioning information from the image data. By using the positioning unit, the tightening device may autonomously tighten the nuts of the flange connection according to a predefined tightening sequence. Furthermore, the positioning device ensures, that each nut, which has to be tightened is aligned with the tightening device according to specification.

The tightening device may also comprise a nut tightening unit and two propulsion units disposed on essentially opposite sides of the nut tightening unit, wherein in the operating state of the tightening device, each continuous drive of each propulsion unit is disposed essentially on the nut plane on one or more top surfaces of one or more of the nuts. By providing two continuous drives on opposite sides of the tightening unit, the smoothness of the movement of the tightening device can be improved.

The propulsion unit may also comprise two guide elements, which in the operating state of the tightening device are facing opposite side surfaces of one or more of the nuts or bolts of the flange connection. This improves the guiding effect when operating the tightening device at high speeds.

Furthermore, the continuous drive may comprise two chains, wherein in the operating state of the tightening device, each chain is disposed on an opposite side of at least one bolt essentially on the nut plane on one or more top surfaces of one or more of the nuts. Hereby an increased surface area can be utilized for traction of the continuous drive.

The tightening device according to the invention as well as preferred and alternative embodiments will be described hereinbelow with reference to the figures.

### BRIEF DESCRIPTION OF THE DRAWINGS

FIG. 1 shows a frontal view of a tightening device according to the invention.

FIG. 2 shows the tightening device according to the invention in a perspective view.

FIG. 3 shows a cross sectional view of the tightening device according to the invention.

FIG. 4 shows a propulsion unit of the tightening device according to the invention in a frontal view.

FIG. 5 shows the propulsion unit of FIG. 4 in a side view.

FIG. 6 shows the propulsion unit of the tightening according to FIG. 4 placed on a series of nuts of a flange connection.

FIG. 7 shows the propulsion unit of FIG. 6 in a side view.

### DETAILED DESCRIPTION

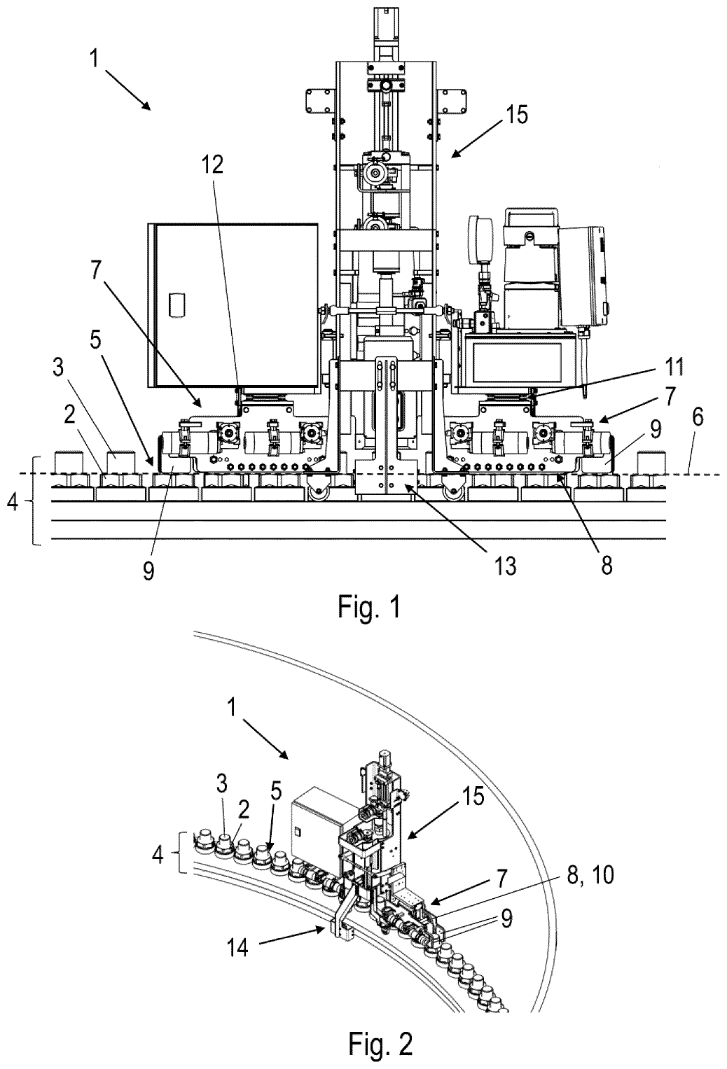

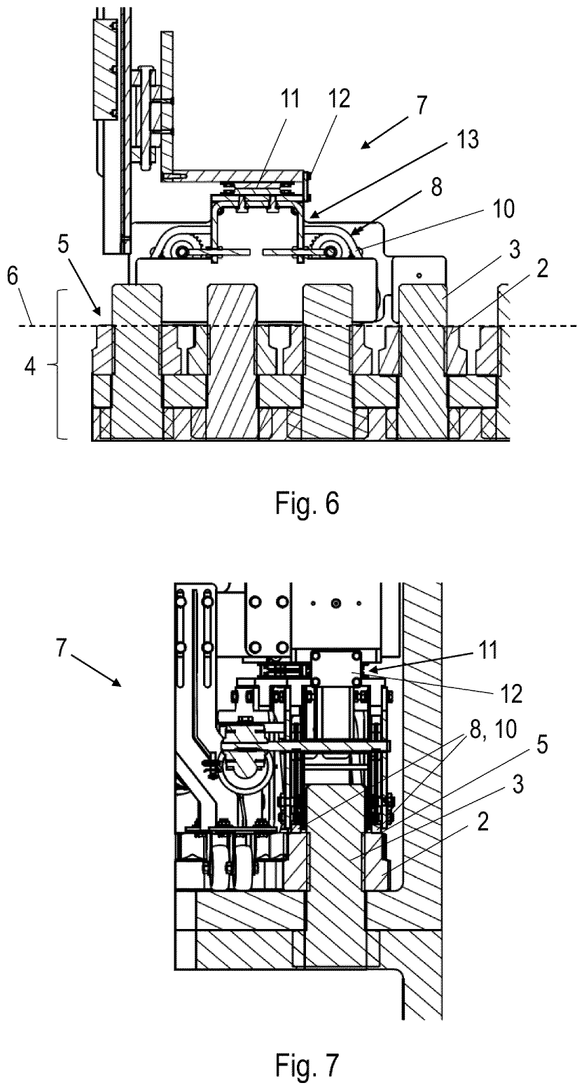

A tightening device 1 according to the invention is shown in FIG. 1 in a preferred embodiment in a frontal view and in FIG. 2 in a perspective view in an operating state. The tightening device 1 is designed for tightening a series of nuts 2 pre-screwed on bolts 3, which bolts 3 are arranged in a linear or in a curved flange connection 4. Each nut 2 comprises a top surface 5 located at one end of the nut 2, wherein the top surfaces 5 are arranged in a nut plane 6 of the flange connection 4, and wherein the tightening device 1 comprises a propulsion unit 7 for moving the tightening device 1 along the flange connection 4. According to the invention, the propulsion unit 7 comprises a continuous drive 8, wherein in the operating state of the tightening device 1, the continuous drive 8 is disposed essentially on the nut plane 6 on one or more top surfaces 5 of one or more of the nuts 2. This is shown in further detail in FIG. 6 and FIG. 7. The continuous drive 8 therefore uses the top surfaces 5 of the nuts 2 as a drive surface for propelling the tightening device 1 along the flange connection 4 in either direction. Since the top surfaces 5 naturally align in the nut plane 6 due to the weight of the bolts 3, which traverse the flange connection 4, the top surfaces 5 provide a level drive surface. By using the continuous drive 8 according to the invention, these top surfaces 5 can be used to propel the tightening device 1 forward. The top surfaces 5 are also naturally free form obstacles like tools or other equipment, which may hinder the movement of the tightening device 1. By using the continuous drive 8, spaces between the nuts 2 can also easily be bridged, which results in a smooth movement of the tightening device 1. In order to bridge these gaps or spaces between the nuts 2, the continuous drive 8 preferably has a length, which is greater than a gap width between two adjacent nuts 2. The continuous drive 8 also has the advantage, that it is able to grip edges of the nuts 2 which results in increased traction on the nuts 2. The construction of the tightening device 1 according to the invention therefore provides a reliable and robust means of propulsion for the tightening device 1, which is simple and easy to construct.

According to the preferred embodiment of the tightening device 1 according to the invention, the propulsion unit 7 comprises a guide element 9, which in the operating state of the tightening device 1 is preferably facing a side surface of one or more of the nuts 2 or bolts 3 of the flange connection 4. As can be seen in FIG. 1 and FIG. 2, the guide element 9 is arranged facing a side surface of the bolts 3. Preferably, two guide elements 9 are provided on each propulsion unit 7, which are arranged on opposite sides of the nuts 2 and/or bolts 3 in the operating state of the tightening device 1. The provision of one or more guide elements 9 secures, that the continuous drive 8 is aligned with the curvature of the flange connection 4 during operation or during movement of the tightening device 1.

The continuous drive 8 preferably comprises a chain 10 of interlinked chain segments, which are not shown in the figures in detail. The chain 10 can be seen for example, in FIG. 6. These chain segments work like chain segments of a tank chain or a chain of an excavator. One or more of these chain segments preferably comprise a friction element oriented towards the nut plane 6 in the operating state of the tightening device 1, wherein the friction element is preferably made of a rubber or plastic material. The friction elements increase the traction of the continuous drive 8 on the top surfaces 5 of the nuts 2, and furthermore reduce wear and tear on the continuous drive 8. Preferably each of the chain segments comprises at least one friction element. The friction elements may be replaceable, or permanently fixed to the chain segments. They may for example be glued or riveted to the chain segments. Replaceable friction elements increase the service life of the continuous drive 8, wherein permanently fixed friction elements reduce the risk of losing one or more of the friction elements during operation of the tightening device 1. The chain 10 is, in an operating state of the tightening device 1, disposed essentially on the nut plane 6 on one or more top surfaces 5 of one or more of the nuts 2. According to an alternative embodiment, the continuous drive 8 may comprise a drive belt, which may have a circular or a flat cross section wherein in an operating state of the tightening device 1, the drive belt is disposed essentially on the nut plane 6 on one or more top surfaces 5 of one or more of the nuts 2.

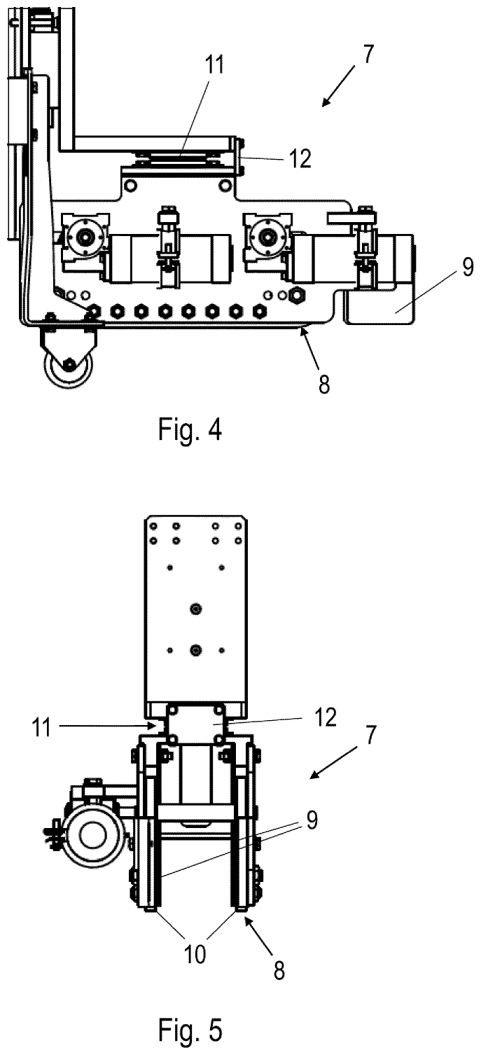

As can be seen in FIG. 1 and FIG. 4, the propulsion unit 7 of the tightening device 1 according to the invention comprises, according to the preferred embodiment, a swivel joint 11, which pivotally supports the continuous drive 8. The swivel joint 11 ensures, that the continuous drive 8 can follow narrow curvatures of the flange connection 4. The swivel joint 11 may also comprise a locking mechanism or a locking plate 12 in order to lock the movement of the swivel joint 11 if necessary. The locking plate 12 is shown in FIG. 4 and FIG. 5.

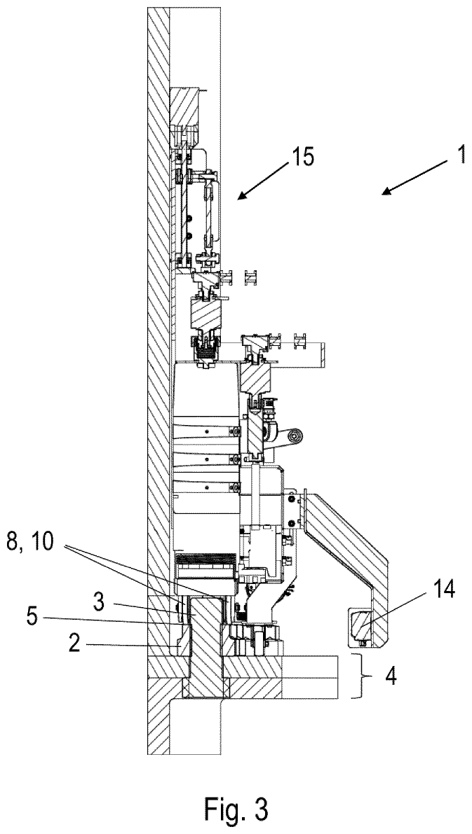

The continuous drive 8 may also comprise a tensioning mechanism 13 as shown in FIG. 6. Furthermore, the tightening device 1 may also comprise a positioning unit, which is adapted to control the continuous drive 8 according to positioning information. The positioning unit may also comprise a camera 14, which is shown in FIGS. 1, 2 and 3, which in the operating state of the tightening device 1 is configured to capture image data of the flange connection 4, wherein the positioning unit is configured to extract the positioning information from the image data. The positioning unit enables the tightening device 1 to precisely position itself over a specific nut 2 in order to tighten it. Furthermore, the positioning unit enables the tightening device 1 to tighten the nuts 2 according to a specific tightening sequence.

The tightening device 1 furthermore comprises a nut tightening unit 15 for tightening the nuts 2, and preferably two propulsion units 7 with continuous drives 8 disposed on essentially opposite sides of the nut tightening unit 15, as can be seen in FIG. 1. In the operating state of the tightening device 1, according to this embodiment, each continuous drive 8 is disposed essentially on the nut plane 6 on one or more top surfaces 5 of one or more of the nuts 2. The provision of two separate continuous drives 8 the smoothness of the movement of the tightening device 1 can be improved, and an increased drive surface for the propulsion of the tightening device 1 can be used.

The propulsion unit 7 according to the preferred embodiment as shown in the figures may also comprise two guide elements 9, as shown in FIG. 2, which in the operating state of the tightening device 1 are facing opposite side surfaces of one or more of the nuts 2 or bolts 3 of the flange connection 4. This is shown for example in FIG. 5 and FIG. 7. This improves the guiding effect when operating the tightening device at high speeds.

Furthermore, the continuous drive 8 may comprise two chains 10, wherein in the operating state of the tightening device, each chain 10 is disposed on an opposite side of at least one bolt 3 essentially on the nut plane 6 on one or more top surfaces 5 of one or more of the nuts 2. Hereby an increased surface area can be utilized for traction of the continuous drive 8. This configuration of the chains 10 is shown for example in FIG. 5 and FIG. 7. One or both of these chains 10 may according to an alternative embodiment be replaced by belts.

What is claimed is:

1. A tightening device (1) for tightening a series of nuts (2) pre-screwed on bolts (3), which bolts (3) are arranged in a linear or in a curved flange connection (4), wherein each nut (2) comprises a top surface (5) located at one end of the nut (2), wherein the top surfaces (5) are arranged in a nut plane (6) of the flange connection (4), and wherein the tightening device (1) comprises a propulsion unit (7) for moving the tightening device (1) along the flange connection (4), characterized in that
the propulsion unit (7) comprises a continuous drive (8), wherein in an operating state of the tightening device (1), the continuous drive (8) is disposed essentially on the nut plane (6) on one or more top surfaces (5) of one or more of the nuts (2).

2. The tightening device (1) according to claim 1, characterized in that the propulsion unit (7) comprises a guide element (9), which in the operating state of the tightening device (1) is preferably facing a side surface of one or more of the nuts (2) or bolts (3) of the flange connection (4).

3. The tightening device (1) according to claim 1, characterized in that the continuous drive (8) comprises a chain (10) of interlinked chain segments, wherein one or more of the chain segments preferably comprises a friction element oriented towards the nut plane (6) in the operating state, wherein the friction element is preferably made of a rubber or plastic material.

4. The tightening device (1) according to claim 3, characterized in that the friction element is replaceable.

5. The tightening device (1) according to claim 3, characterized in that the friction element is glued to the chain segment.

6. The tightening device (1) according to claim 3, characterized in that each of the chain segments comprises at least one friction element.

7. The tightening device (1) according to claim 1, characterized in that the propulsion unit (7) comprises a swivel joint (11), which pivotably supports the continuous drive (8).

8. The tightening device (1) according to claim 1, characterized in that the tightening device (1) comprises a positioning unit, which is adapted to control the continuous drive (8) according to positioning information.

9. The tightening device (1) according to claim 8, characterized in that the positioning unit comprises a camera (14), which in the operating state of the tightening device (1) is configured to capture image data of the flange connection (4), wherein the positioning unit is configured to extract the positioning information from the image data.

10. The tightening device (1) according to claim 1, characterized in that the tightening device (1) comprises a nut tightening unit (15) and two propulsion units (7) disposed on essentially opposite sides of the nut tightening unit (15), wherein in the operating state of the tightening device (1), each continuous drive (8) of each propulsion unit (7) is disposed essentially on the nut plane (6) on one or more top surfaces (5) of one or more of the nuts (2).

11. The tightening device (1) according to claim 1, characterized in that the propulsion unit (7) comprises two guide elements (9), which in the operating state of the tightening device (1) are facing opposite side surfaces of one or more of the nuts (2) or bolts (3) of the flange connection (4).

12. The tightening device (1) according to claim 1, characterized in that the continuous drive (8) comprises two chains (10) of interlinked chain segments, wherein in the operating state of the tightening device (1), each chain (10) is disposed on an opposite side of at least one bolt (3) essentially on the nut plane (6) on one or more top surfaces (5) of one or more of the nuts (2).
